(19) United States
(12) Patent Application Publication
(10) Pub. No.: US 2017/0056130 A1
(43) Pub. Date: Mar. 2, 2017

(54) AIR COOLED DENTAL PHOTOCURING LIGHT AND METHOD OF USING SAME

(71) Applicant: James L. Cannon, Murrayville, GA (US)

(72) Inventor: James L. Cannon, Murrayville, GA (US)

(21) Appl. No.: 14/841,839

(22) Filed: Sep. 1, 2015

(51) Int. Cl. A61C 1/00; A61C 1/08; A61C 13/15

(52) U.S. Cl. CPC A61C 1/0069; A61C 19/004; A61C 1/088

(57) ABSTRACT

The invention comprises a tool. The tool comprises a hollow tool body having a light source disposed adjacent a first end thereof, the hollow tool body defining a first opening adjacent the first end, wherein the light source is disposed so that light from the light source is directed through the first opening. The tool also comprises a transparent member disposed in the first opening so that light from the light source passes through the transparent member, wherein the transparent member defines a second opening. The tool further comprises a third opening defined by the hollow tool body for introducing pressurized air into the hollow tool body so that pressurized air introduced through the third opening is exhausted from the hollow tool body through the second opening. A method of using the tool is also disclosed.

### FIELD OF THE INVENTION

The present invention generally relates to an oral examination/dental curing light. More particularly, this invention relates to an oral examination/dental curing light for curing dental adhesives, polymers and other photo curable materials. Specifically, the present invention relates to an oral examination/dental curing light including an air-cooling system. A method of using the oral examination/dental curing light is also disclosed.

### BACKGROUND OF THE INVENTION

In the practice of corrective orthodontia, orthodontic attachments are typically bonded to the labial surface of teeth and metal wires are attached to the attachments to exert forces on the attachments to slowly move the teeth into proper alignment. Examples of orthodontic brackets are shown in U.S. Pat. Nos. 5,512,838; 5,248,257 and 7,329,120 (the disclosures of which are all incorporated herein by reference). The bonding of orthodontic attachments to teeth has been in existence for at least 35 years. The bonding of orthodontic attachments to teeth is typically accomplished with a photo curable polymeric adhesive or an adhesive whose curing is accelerated or initiated by exposure to light, typically blue, violet or ultraviolet light. Such adhesives and polymers are also employed in general dentistry for use with polymeric composites associated with fillings, adhesives associated with crowns and the like.

A dental instrument including a curing light for example a LED light, such as a blue, violet or UV LED, is typically placed near or in a patient's mouth so that the light from the instrument can illuminate the photo curable polymer-based material to be cured or to initiate polymerization. In order to reduce the amount of time required to cure or initiate polymerization, the intensity of the light used for such purpose has increased considerably. However, such high intensity lights, such as blue, violet or UV LED lights, produce a considerable amount of heat. Therefore, some prior art dental curing lights use a significant amount of insulation around the light. This increases the size of the instrument making it bulky and more difficult to fit into a patient's mouth. Those devices using less insulation can get uncomfortably warm with continuous operation. Furthermore, not only does the tool get hot, but the illuminated tooth and adjacent oral tissue or the illuminated oral tissue can also get uncomfortably warm. Such dental examination/curing lights can also be used for other dental or medical procedures, such as teeth whitening, cavity detection and oral tissue examination, for example for cancer detection. U.S. Pat. No. 8,786,689 (the disclosure of which is incorporated herein by reference in its entirety) is an example of an oral examination and/or dental curing light in the filed of the present invention.

It would therefore be desirable to provide an oral examination/dental curing light including a light source, for example a white, blue, violet or UV high intensity LED light, that does not get as hot as prior art devices. It would also be desirable to provide an oral examination/dental curing light that does not get the illuminated tooth and adjacent oral tissue or the illuminated oral tissue as hot as prior art devices.

### SUMMARY OF THE INVENTION

The present invention satisfies the foregoing needs by providing a tool for illumination of oral tissue, teeth and/or curing photo curable adhesives, polymers or other photo curable materials. The tool comprises a hollow tool body having a light source disposed in a first end thereof, the opposite second end of the tool body is substantially sealed, the hollow tool body defines a first opening at the first end, wherein the light source is disposed so that the light from the light source is directed through the first opening. The tool also comprises a transparent member disposed in the first opening so that light from the light source passes through the transparent member, wherein the transparent member defines a second opening. The tool further comprises a third opening defined by the hollow tool body for introducing pressurized air into the hollow tool body so that pressurized air introduced through the third opening is exhausted from the hollow tool body through the second opening.

In another disclosed embodiment, the present invention comprises a method. The method comprises introducing pressurized air into a hollow tool body, the hollow tool body having a light source disposed in a first end thereof, the opposite second end of the tool body being substantially sealed, the hollow tool body defining a first opening at the first end, wherein the light source is disposed so that the light from the light source is directed through the first opening, the hollow tool body having a transparent member adjacent the first opening so that light from the light source passes through the transparent member. The method also comprises exhausting pressurized air in the hollow tool body through the second opening.

In another disclosed embodiment, the present invention comprises a method. The method comprises providing pressurized air to a tool body, the tool body having a light source disposed in a first end thereof, the tool body defining a first opening at the first end, wherein the light source is disposed so that light from the light source is directed through the first opening, the tool body defining a second opening. The method also comprises directing light from the light source to a focal point distal from the tool body. The method further comprises exhausting pressurized air from the tool body through the second opening toward the focal point.

Accordingly, it is an object of the present invention to provide an improved dental tool for curing photo curable substances, such as adhesives, polymers and other photo curable materials.

Another object of the present invention is to provide a system for cooling the light source in a dental tool for curing photo curable substances.

A further object of the present invention is to provide a dental tool for curing photo curable substances that is safer to use.

Another object of the present invention is to provide a dental tool for curing photo curable substances that is more comfortable to use.

Another object of the present invention is to provide a dental tool for illuminating oral tissue.

A further object of the present invention is to provide a dental tool that directs pressurized air toward teeth, oral tissue or photo curable substances illuminated by a light in the tool.

Another object of the present invention is to provide a dental tool that both illuminates teeth and/or oral tissue and also cools the illuminated teeth and/or oral tissue so that the illumination does not unduly heat the teeth and/or oral tissue.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a perspective view of a disclosed embodiment of the dental tool of the present invention.

FIG. 2 is a top plan of the dental tool shown in FIG. 1.

FIG. 3 is a side view of the dental tool shown in FIG. 1.

FIG. 4 is a bottom plan view of the dental tool shown in FIG. 1.

FIG. 5 is a cross-sectional view taken along the line 5-5 of the dental tool shown in FIG. 2.

FIG. 6 is a detail partial cross-sectional view of the dental tool shown in FIG. 5.

FIG. 7 is a bottom plan view of the dental tool shown in FIG. 1 shown with a barrier sleeve, spacer ring and exhaust tube mounted on the dental tool.

FIG. 8 is a detail partial cross-sectional view taken along the line 8-8 of the dental tool shown in FIG. 7.

### DETAILED DESCRIPTION OF THE DISCLOSED EMBODIMENTS

As used herein, the terms “cure”, “curing” and variations thereof as applied to the term “adhesive,” “polymer” or “photo curable material” includes both curing all or a portion of the adhesive, polymer or photo curable material and/or initiating the curing of the adhesive, polymer or photo curable material.

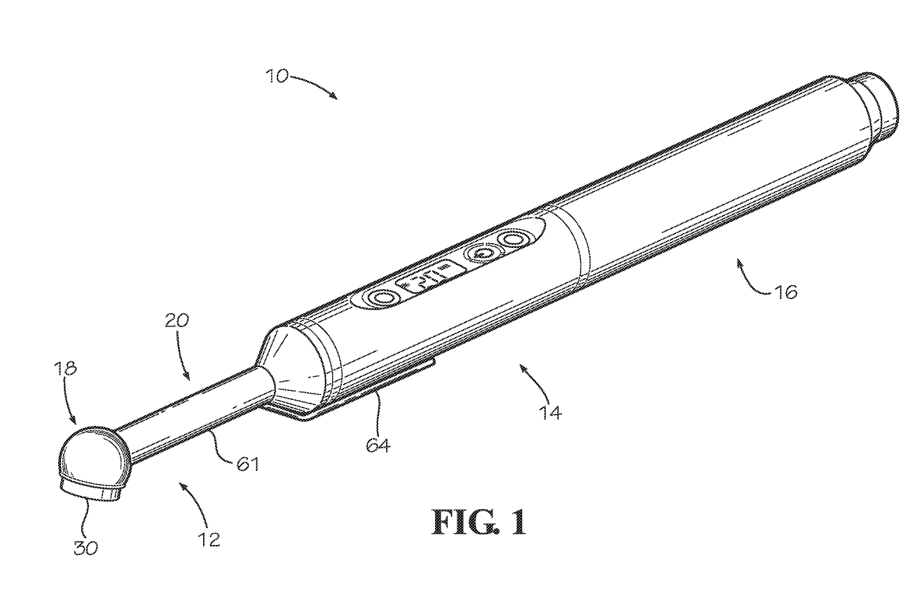

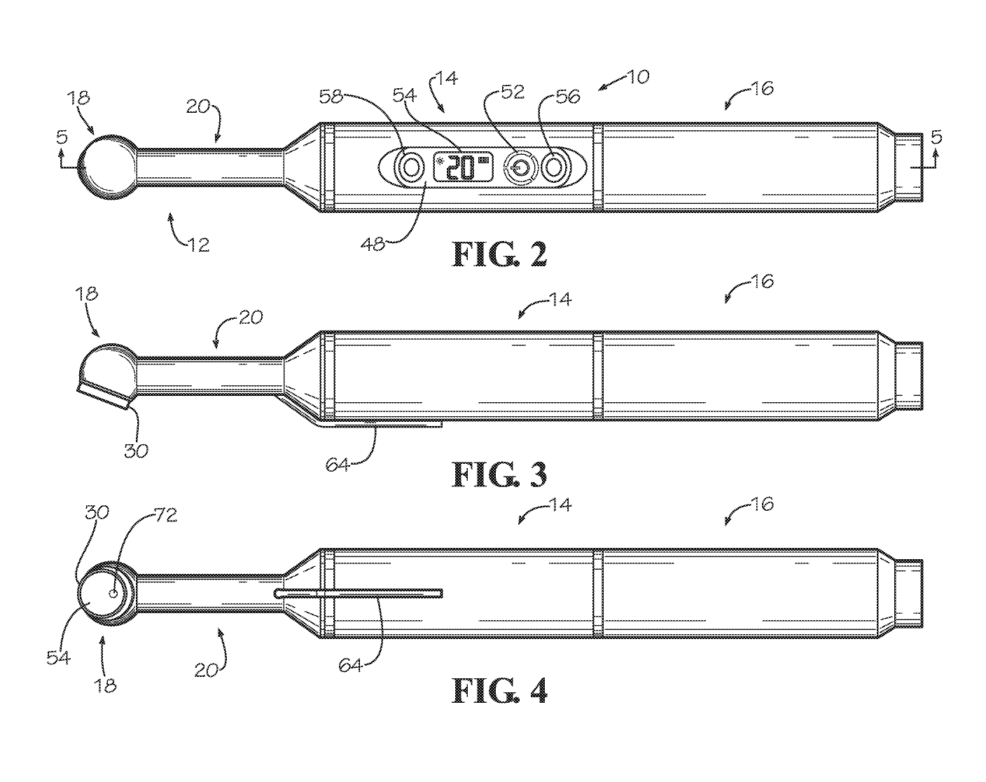

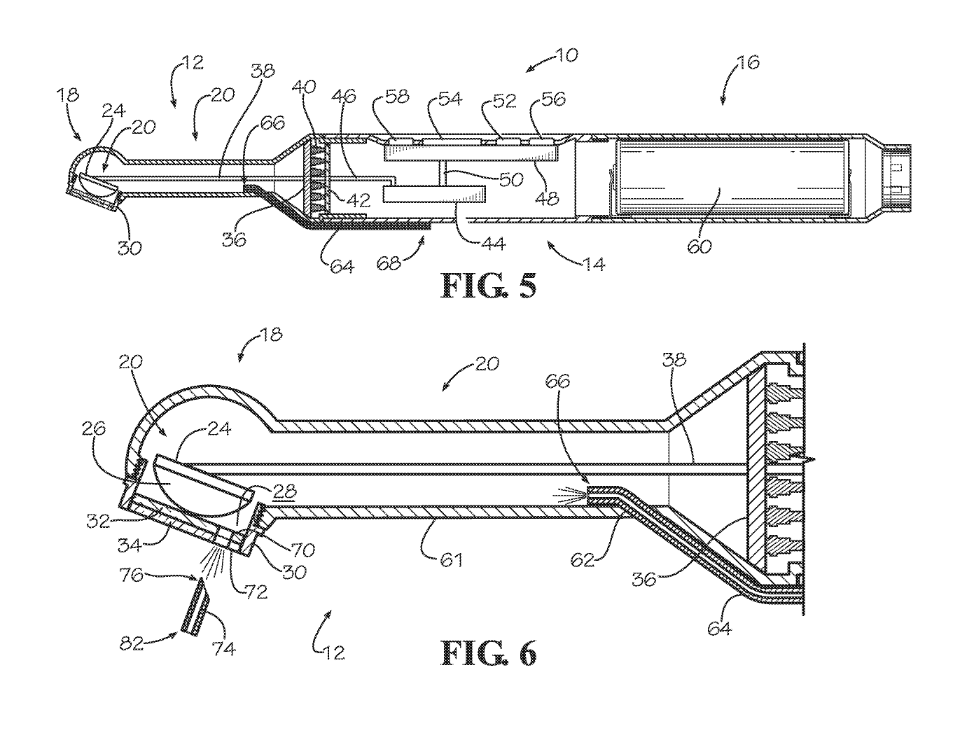

Referring now to the drawing in which like numbers indicate like elements throughout the several views, there is shown in FIG. 1 a disclosed embodiment of a medical/dental light tool 10 in accordance with the present invention. The tool 10 comprises an interchangeable light portion 12, a controller portion 14 and a power portion 16. The light portion 12 is removable attached to the controller portion 14 and the controller portion is removable attached to the power portion 16.

The light portion 12 includes a rounded hemispherical head portion 18 and an elongate tubular neck portion 20. The head portion 18 and the neck portion 20 are hollow and jointly form a hollow tool body. The head portion 18 is formed at one end of the hollow tool body. Mounted in the hollow head portion 18 is an LED light assembly 20. The LED light assembly 20 includes a high intensity LED 24. The LED 24 produces high intensity light, which can be visible light or invisible light; e.g., white, blue, violet or UV light, depending on the intended use of the tool 10. For curing adhesives, polymer or other photo curable materials, the light is preferably blue, violet or UV. For oral tissue examination, the light is preferably white or UV. Since the light portion 12 is removable, a light portion including an LED of the desired light emitting characteristics or desired light wavelength can be chosen depending on the intended use. A directional collimating hyper-hemispherical lens 26 is mounted adjacent the LED 24 so that light emitted by the LED passes through the lens 26.

The head portion 18 defines an opening 28. The LED 24 and lens 26 are mounted in the head portion 18 so that light emitted by the LED and passing through the lens is directed out of the head portion through the opening 28. Detachably mounted in the opening 28 is a lens assembly 30 (FIG. 6). The lens assembly 30 comprises a Fresnel collimating lens 32 and a transparent lens-protecting disk 34. The purpose of the lens 26, the lens 32 and the protecting disk 34 is to focus the light from the LED 24 at a focal point distal from the tool 10 so that the intensity of the light is increased and the light is confined to an desired area for treatment or examination, for example, a tooth, an adhesive, a polymer, other photo curable materials or oral tissue. The lens 26, the lens 32 and the protecting disk 34 are all made from transparent materials. The lens 32 and the protecting disk 34 are mounted to the lens assembly 30 by standard lens mounting techniques known in the art, such as by bonding or sealing them to the interior rim of the lens mounting assembly. When the lens assembly 30 is attached to the head portion 18, such as by screwing, the lens assembly provides a substantially air tight seal to the opening 28 of the head portion.

The LED 24 is connected to an LED drive board 36 by an electric connection, such as by the wires 38. Affixed to the LED drive board 36 are a plurality of spring loaded pins, such as the pin 40. The spring loaded pins, such as the pin 40, mate with sockets (not shown) formed in a control connection board 42 mounted in the controller portion 14. The spring loaded pins, such as the pin 40, allow the light portion 12 to be plugged into and unplugged from the controller portion 14, thereby establishing an electrical connection between the light portion and the controller portion. This allows one light portion 12 containing an LED of one wavelength to be mechanically and electrically disconnected from the controller portion 14 and a light portion with an LED of a different wavelength to be mechanically and electrically connected to the controller portion.

The control connection board 42 is connected to a control circuit board or controller circuitry 44 by an electric connection, such as by the wires 46. The controller circuitry 44 is connected to an LCD display and switch board 48 by an electric connection, such as by the wires 50. The LCD display and switch board 48 includes an on/off switch 52, an LCD display 54, an operation mode menu key 56 and a power selection key 58. The on/off key 52 activates and deactivates the light portion 12. The mode menu key 56 selects pre-programmed timing sequences and operating modes of the light portion 12. The LCD display 52 shows, among other things, the amount of time that the LED 24 will be energized. The controller portion 14 is connected to the power portion 16 by a plurality of spring loaded pins (not shown) that provide an electrical connection with a rechargeable battery 60 disposed in the power portion 16. The battery 60 provides electricity to the LED 24 in order to produce light. The controller portion 14 regulates the intensity and the duration of the light produced by the LED 24.

The tool 10 described above is disclosed in greater detail in U.S. Pat. No. 8,786,689 (the disclosure of which is incorporated herein by reference in its entirety). The tool 10 described above is also commercially available under the designation Fusion 4 Ortho Curing Light from DentLight, Plano, Tex. 75704. A disclosed embodiment of the present invention comprises a modification to the tool 10 described above. That modification is described below.

As stated above, the head portion 18 and the neck portion 20 of the tool body are hollow. The neck portion 20 comprises a tubular sidewall 61. A hole 62 is formed in the sidewall 61 of the neck portion 20, such as by drilling. A hollow tube 64 is disposed in the hole 62 and a polymer sealant (not shown) is placed around the tube at the interface with the sidewall 61 so as to seal the tube to the neck portion. The polymer sealant provides a substantially air tight seal between the tube 64 and the sidewall 61 of the neck portion 20. The tube 64 has a first end 66 and an opposite second end 68. The first end 66 is disposed in the hollow neck portion 20. One end of a flexible tube (not shown) is attached to the second end 68 of the tube 64. The other end of the flexible tube (not shown) is attached to a source of pressurized air (not shown). A source of pressurized air is usually available in a dental office. Therefore, pressurized air applied to the second end 68 of the tube 64 travels through the tube and exits the first end 66 within the hollow neck portion 20.

As described above, the lens assembly 30 includes a Fresnel collimating lens 32 and a transparent lens-protecting disk 34. A hole 70 is formed in the transparent Fresnel collimating lens 32, such as by drilling. A hole 72 is similarly formed in the transparent protecting disk 34, such as by drilling. In other embodiments, the lens assembly may include only a single transparent member or three or more transparent members. It is an essential element of the present invention that holes be formed in all transparent members in the lens assembly between the outside of the tool 10 and the hollow interior portion of the head portion 18.

The hollow head portion 18 and the hollow neck portion 20 are in fluid communication so that pressurized air from the first end 66 of the tube 64 flows through the hollow neck portion to the hollow head portion. The control portion 14 and power portion 16 when attached to the light portion 12, provide a substantially air tight seal to the end of the light portion opposite the head portion 18. Therefore, pressurized air in the head portion 18 is then exhausted through the holes 70, 72. The LED 24 and lens 26 are mounted in the head portion 18 so that pressurized air flowing from the neck portion 20 to the head portion flows around the LED (and/or a heat sink, not shown, associated with the LED, if present) so that there is a transfer of heat from the LED to the flowing air. The pressurized air heated by the LED 24 is then exhausted through the holes 70, 72. Thus, there is an air pathway from the first end 66 of the tube 64 to the LED 24 and to the holes 70, 72.

A hollow exhaust tube 74 is insertable into the holes 72, 70. When inserted in the holes 72, 70, the tube 74 extends outwardly from the transparent protecting disk 34. Pressurized air in the head portion 18 exhausts through the tube 74 when inserted in the holes 72, 70. Air exhausted through the tube 74 is directed toward the focal point of the light from the LED 24. One end of the tube 74 is cut at an angle so as to provide a sharp point 76. The tube 74 is inserted into the holes 72, 70 with the sharp point 76 facing the holes. The outside diameter of the tube 74 is approximately equal to the inside diameter of the holes 72, 70, so that when inserted in the holes the tube is temporarily retained in the holes by friction. When desired, as described further below, the tube 74 can be removed from the holes 72, 70 by manually pulling the tube away from the head portion 18. The tube 74 can then be discarded after use.

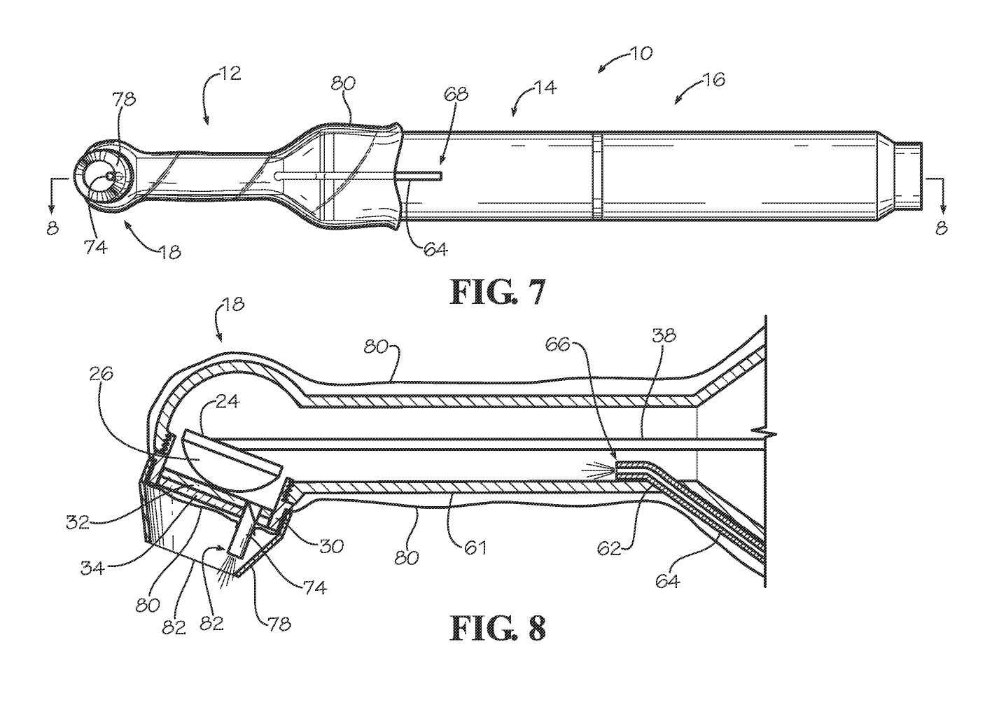

Optionally, a spacer ring 78 is attachable to the lens assembly 30 (FIGS. 7 and 8). The spacer ring 78 allows the tool 10 to be placed directly in contact with, for example, a tooth while providing proper spacing from the LED 24 and providing stability to the tool while being handheld manually. The spacer ring 78 also prevents scattering of the light from the LED 24 and is typically made from material that filters out harmful light wavelengths, which provides additional eye protection to an operator. The spacer ring 78 is available in different sizes, such as 3 mm, 9 mm and 13 mm, which when attached to the lens assembly 30 allows different spacing from the object to be illuminated with the light from the LED 24. Such spacer rings are commercially available for the Fusion 4 Ortho Curing Light.

Use of the tool 10 will now be considered. A light portion 12 having an LED 24 that produces light of a desired wavelength range, such as white, blue, violet or UV, is attached to the control portion 14, which is attached to the power portion 16. Before the light tool 10 is placed in a patient's oral cavity, for sanitary purposes a sterile plastic barrier sleeve 80 is place over the light portion 12 (FIGS. 7 and 8). The plastic sleeve 80 is made from a relatively thin, flexible plastic film suitable for use in the dental and orthodontic field. Such plastic sleeves 80 are commercially available for the Fusion 4 Ortho Curing Light. The plastic sleeve 80 fits closely over the lens-protecting disk 34 and covers the hole 72 (FIG. 8). The tube 74 is inserted into the holes 72, 70 with the sharp point 76 facing the holes. The sharp point 76 of the tube 74 is used to pierce the plastic sleeve 80 as the tube is inserted into the holes 72, 70. By piercing the plastic sleeve 80 as described above, the plastic sleeve fits tightly around the tube 74. After the tube 74 is positioned in the holes 72, 70, the end of the tube 82 opposite the sharp point 76 extends outwardly from the lens-protecting disk 34 and from the plastic sleeve 80. After the tube 74 is positioned in the holes 72, 70, the spacer ring 78 is optionally attached to the lens assembly 30, as shown in FIGS. 7 and 8. As can be seen in FIG. 8, the tube 74 is contained within the spacer ring 78 but does not extend beyond the open end 82 of the spacer ring.

A flexible tube (not shown) is connected at one end to a source of pressurized air (not shown). The other end of the flexible hose (not shown) is attached to the end 68 of the tube 64 so that pressurized air is delivered to the tube 64. The pressurized air exits the tube 64 at the end 66 and enters the hollow neck portion 20. The pressurized air travels from the neck portion 20 to the head portion 18. The pressurized air in the head portion 18 flows around the LED 24 and absorbs heat from the LED when the LED is energized. The pressurized air then flows out of the head portion 18 through the tube 74 disposed in the holes 72, 70.

The amount of time it is desired to have the LED 24 produce light is selected by pressing the power selection key 58. The tool 10 is positioned as desired in a patient's oral cavity. For example, to cure a photo curable adhesive for attaching an orthodontic bracket to a tooth, the head portion 18 is positioned adjacent the tooth with the bracket positioned thereon and held in place by a quantity of uncured photo curable adhesive. The tool 10 is positioned so that the light beam from the head portion 18 is directed toward the tooth, adhesive and bracket. If a spacer ring 78 is used, the open end 82 of the spacer ring distal from the head portion can be rested on the tooth and/or bracket. This provides optimal spacing of the LED 24 from the adhesive to be cured. Then, the tool 10 is turned on by pressing the on/off switch 52 thereby providing electricity from the battery 60 to the LED 24 for the selected amount of time. When the LED 24 is energized, it produces high intensity light, which passes through the lens 26, the lens 32 and the lens-protecting disk 34. Since the lens 26, the lens 32 and the lens-protecting disk 34 are transparent, the light from the LED 24 passes through relatively undiminished. The lens 26 and the lens 32 function to focus the light from the LED 24 into a more focused parallel beam, which is focused on the photo curable adhesive associated with the orthodontic bracket.

During the foregoing procedure, pressurized air flows through the tool 10 as described above. When the LED 24 is energized, it produces a relatively large amount of heat. The pressurized air flowing past the LED 24 absorbs a portion of the heat produced by the LED. The pressurized air in the head portion 18, which include air that has absorbed heat from the LED 24, is then exhausted through the tube 74 in the holes 72, 70. The pressurized air exiting the end 82 of the tube 74 is directed at toward the approximate same location that the beam of light from the tool 10 is focused. Although the pressurized air exiting the end 82 of the tube 74 has absorbed some of the heat produced by the LED 24, it is still relatively cool. Since the pressurized air exiting the end 82 of the tube 74 is directed toward the focal point of the light from the LED 24, the pressurized air passing over the tooth, bracket and adjacent oral tissue absorbs some heat from the tooth, bracket and adjacent oral tissue and therefore cools the tooth, bracket and adjacent oral tissue thereby preventing uncomfortable heating of the tooth, bracket and adjacent oral tissue caused by the high intensity light from the LED. Since the pressurized air absorbs some of the heat from the LED 24 and exhausts it from the head portion 18, the head portion does not get uncomfortably hot and prevents accidental burning of oral tissue by accidentally touching the head portion to a patient's oral tissue. The light from the LED 24 is automatically turned off after the desired amount of time by the electronic control circuitry in the controller portion 14.

The air cooling system of the present invention, as described above, therefore provides at least two benefits. First, it reduces the heat produced by the LED 24. Second, it provides cooling air to the focal point of the high intensity light from the LED 24, thereby preventing uncomfortable heating by the high intensity light. This makes for a more comfortable and enjoyable experience by the patient.

After the photo curable adhesive has been exposed to the light from the tool 10 for a desired amount of time, the light portion 18 is removed from the patient's oral cavity. The spacer ring 78 is removed from the lens assembly 30 and is discarded. The tube 74 is removed from the holes 72, 70 and the tube is discarded. Then, the barrier sleeve 80 is removed from the light portion 12 and the sleeve is discarded. The flexible tube (not shown) is removed from the end 68 of the tube 64. The light portion 12 is then wiped with an appropriate dental disinfectant.

As used herein, the term “substantially air tight” means that the head portion 18 is sufficiently sealed so that the majority of the pressurized air from the end 66 of the tube 64 is exhausted through the holes 70, 72.

It should be understood, of course, that the foregoing relates only to certain disclosed embodiments of the present invention and that numerous modifications or alterations may be made therein without departing from the spirit and scope of the invention as set forth in the appended claims.

1. A tool comprising:
a hollow tool body having a light source disposed in a first end thereof, the hollow tool body defining a first opening adjacent the first end, wherein the light source is disposed so that the light from the light source is directed through the first opening;
a transparent member disposed in the first opening so that light from the light source passes through the transparent member, wherein the transparent member defines a second opening; and
a third opening defined by the hollow tool body for introducing pressurized air into the hollow tool body so that pressurized air introduced through the third opening is exhausted from the hollow tool body through the second opening.

2. The tool of claim 1 further comprising a tube disposed in the second opening and extending outwardly from the transparent member so that pressurized air in the hollow tool body is exhausted through the tube.

3. The tool of claim 2, wherein the light from the tool is focused at a focal point distal from the first end of the hollow tool body and wherein the tube is disposed such that the pressurized air exhausted through the tube is directed toward the focal point.

4. The tool of claim 1, wherein the light source is disposed in the hollow tool body so that pressurized air introduced to the hollow tool body absorbs heat from the light source before the pressurized air is exhausted through the second opening.

5. The tool of claim 1, wherein the hollow tool body defines an air pathway from the third opening to the second opening.

6. The tool of claim 5, wherein the light source is disposed in the air pathway intermediate the third and second openings.

7. A method comprising:
introducing pressurized air into a hollow tool body, the hollow tool body having a light source disposed adjacent a first end thereof, the hollow tool body defining a first opening adjacent the first end, wherein the light source is disposed so that the light from the light source is directed through the first opening, the hollow tool body having a transparent member disposed in the first opening so that light from the light source passes through the transparent member, wherein the transparent member defines a second opening; and
exhausting pressurized air in the hollow tool body through the second opening.

8. The method of claim 7, wherein the air exhausted through the second opening in directed by a tube disposed in the second opening and extending outwardly from the transparent member.

9. The method of claim 8, wherein the light from the tool is focused at a focal point distal from the first end of the hollow tool body and wherein the tube directs the air exhausted through the second opening toward the focal point.

10. The method of claim 7, wherein the light source is disposed in the hollow tool body so that pressurized air introduced into the hollow tool body absorbs heat from the light source before the pressurized air is exhausted through the second opening.

11. A method comprising:
providing pressurized air to a hollow tool body, the tool body having a light source disposed adjacent one end thereof, the tool body defining a first opening adjacent the one end, wherein the light source is disposed so that light from the light source is directed through the first opening, and wherein the tool body defines a second opening;
directing light from the light source to a focal point distal from the tool body; and
exhausting pressurized air from the tool body through the second opening toward the focal point.

12. The method of claim 11, wherein the tool body defines an air pathway from the light source to the second opening so that pressurized air in the tool body absorbs heat from the light source before being exhausted through the second opening.

13. The method of claim 11, wherein a transparent member is disposed adjacent the first opening.

14. The method of claim 13, wherein the transparent member focuses light from the light source.

15. The method of claim 13, wherein the second opening is formed in the transparent member.

16. The method of claim 11 further comprising allowing pressurized air in the tool body to absorb heat from the source of light before being exhausted through the second opening.

17. A tool comprising:
a hollow tool body having a light source disposed adjacent a first end thereof;
a first opening defined by the tool body adjacent the first end, wherein the light source is disposed so that the light from the light source is directed through the first opening;
a second opening defined by the tool body adjacent the first opening for exhausting air from the hollow tool body;
a transparent member disposed in the first opening so that light from the light source passes through the transparent member; and
a third opening defined by the hollow tool body for introducing pressurized air into the hollow tool body so that pressurized air introduced through the third opening is exhausted from the hollow tool body through the second opening.

18. The tool of claim 17 further comprising an exhaust tube disposed in the second opening and extending outwardly from the tool body.

19. The tool of claim 18, wherein the tube directs the air exhausted there through in the same direction as the light directed through the first opening.
